(19) United States
(12) Patent Application Publication
(10) Pub. No.: US 2020/0230947 A1
(43) Pub. Date: Jul. 23, 2020

(54) DEVICE FOR PRINTING AN OBJECT WITH A FOIL

(71) Applicant: UNIBIND LIMITED, Egkomi (Nicosia) (CY)

(72) Inventor: Guido Frans M. PELEMAN, Knokke-Heist (BE)

(21) Appl. No.: 16/486,721

(22) PCT Filed: Feb. 13, 2018
(86) PCT No.: PCT/IB2018/050875

§ 371 Date: Aug. 16, 2019

(30) Foreign Application Priority Data
Feb. 16, 2017 (BE) 201705101

(51) Int. Cl. B41F 16/00; B41J 2/325

(52) U.S. Cl. CPC B41F 16/0046; B44C 1/105; B41J 2/325

(57) ABSTRACT

Disclosed is a device for printing an object with a foil, which device includes a needle block with needles that can be heated, a control unit that can determine and set which needles are heated at which moment. The device is also provided with a roller that is positioned rotatably and which can guide the object, when placed on the roller, under the needle block.

The present invention relates to printing an object with a foil.

In particular, the invention is intended to provide, for example, a cover, flyer, banner, cards, etc. with a foil print, such as, for example, a gold or silver foil.

It is known that printing with, for example, a gold or silver foil is applied to give the object an exclusive and prestigious look and character.

Printing with foil is based on a thin polyester foil of typically a couple of microns thick on which a colour is applied first by, for example, vaporisation.

Subsequently a thin layer of typically a couple of microns of hotmelt adhesive is applied.

By putting such foil on an object with the hotmelt adhesive against the surface of the object and then heating it locally, the hotmelt adhesive will melt locally and the coloured foil will attach to the object.

After solidification and removal of the foil, the gold or silver colour foil will remain on the object on the place in question.

Traditionally a heated stamp in which the image is engraved is used, such that this hot stamp can be pressed onto the foil to melt the hotmelt adhesive and to fix it on the object to be printed.

A big disadvantage of such stamp is that every time a new stamp with the desired image needs to be made by engraving or chemical etching. This make the process laborious, very time-consuming and expensive.

A more recent method consists in replacing the stamp with a block of fine heated needles.

These needles are computer-controlled to heat up according to a specific pattern, such that the heated needles melt the hotmelt adhesive according to this pattern.

Consequently, just as with the heated stamp, after solidification of the hotmelt adhesive this pattern will be printed in the coloured foil on the object.

The existing devices that use such needle block work with a system whereby the object to be printed is fixed on a table and the needle block moves horizontal over this table to print the object in the desired locations with the foil.

A disadvantage is that such device takes up a lot of room, for example, 380 millimetres by 330 millimetres. That is a very large area for a shop, office or the like for occasional use.

Another disadvantage is that the length of the print is restricted to the length of the table, for example, 380 millimetres, which usually is too short for banner applications.

The purpose of the present invention is to provide a solution to at least one of the aforementioned and other disadvantages.

The object of the present invention is to print an object with a foil, whereby the device comprises a needle block with needles that can be heated, a control unit that can determine and set which needles are heated at which moment, characterised in that the device is also provided with a roller that is installed rotatably and which can guide the object, when it is placed on the roller, under the needle block.

This provides the advantage that the device can be made in a very compact way, as no table is required to put the object on over which the needle block can move.

Instead, the object will be moved under the needle block by means of the roller.

Another advantage is that the dimensions of the objects that can be printed do not depend on the size of the table.

Moreover, the dimensions of the print will not be limited to the extent to which the needle block can move over the object on the table.

In this way banners or other oblong objects can also be provided with a long print.

In a preferred embodiment, the roller is powered.

The advantage of this is that the speed with which the object moves under the needle block can be controlled by regulating the speed with which the roller is powered.

The roller can be powered by means of a motor or the like.

The control of this motor can be regulated with the same control unit that controls the needle block.

With the intention of better showing the characteristics of the invention, a preferred embodiment of a device for printing an object with a foil according to the invention is described hereinafter, by way of an example without any limiting nature, with reference to the accompanying drawings wherein:

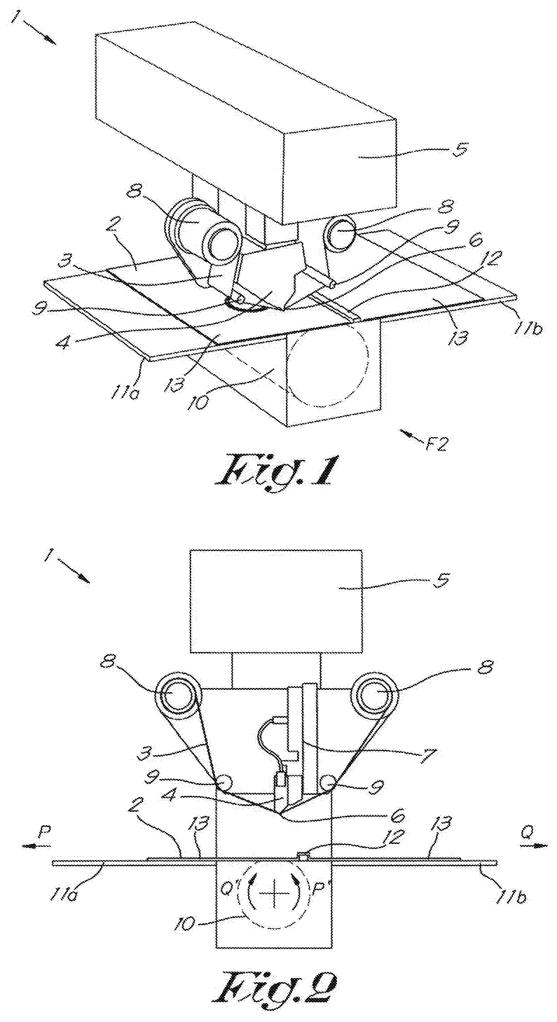

FIG. 1 schematically shows a perspective view of a device according to the invention;

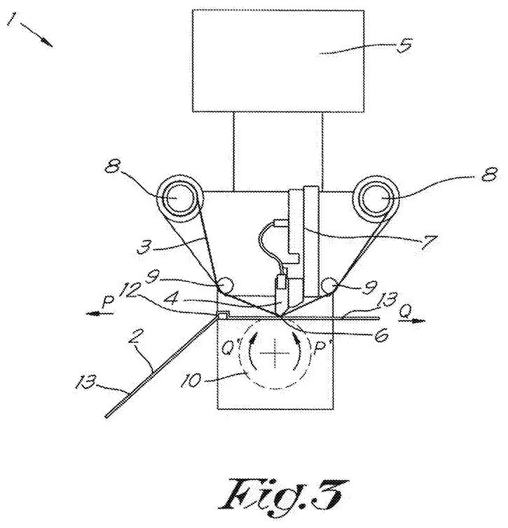

FIG. 2 shows a lateral view of the device of FIG. 1 according to the arrow F2, whereby an object to be printed is applied under the needle block;

FIG. 3 shows the device of FIG. 2, but without lateral guides.

The device 1 according to the invention, schematically shown in FIGS. 1 and 2, for printing an object 2 with a foil 3 essentially comprises a needle block 4 with needles that can be heated and a control unit 5 that can determine and set which needles 6 are heated at which moment.

To this end, the needle block 4 is provided with a heating element 7 which can be controlled by the control unit 5 to regulate when which needles 6 are heated.

To this end, the control unit 5 is provided with the necessary software which will allow the image, text or the like to be printed in foil 3 to be converted into consecutive patterns of different needles 6 that are successively heated.

The device 1 is also provided with two drums 8 on either side of the needle block on which foil 3 can be rolled up, or unrolled respectively, whereby this foil 3 passes along or over the needle block 4.

To guide the foil 3 along the needle block, two guide rods 9 are provided.

This foil 3 will typically consist of a thin polyester foil of typically a few microns thick on which first a colour, for example, silver foil or gold foil, is applied with, for example, vaporisation and on which then a thin layer of typically a few microns of hotmelt adhesive is applied.

The invention is not limited to said two drums 8 with guide rods 9 and it is clear that instead of this, other means can also be provided to pass the foil 3 under or along the needle block 4.

According to the invention, the device 1 is also provided with a roller 10 that is installed rotatably which can guide the object 2, when placed on the roller 10, under the needle block 4 in a lateral direction P or Q as shown in FIG. 2.

Preferably, this roller 10 is powered, this means that the device 1 is provided with, for example, an electric motor or the like that will power the roller 10, this means which makes the roller 10 turn around or rotate respectively in the direction of rotation P′ or Q′.

This electric motor can also be controlled by the control unit 5 such that the rotating speed of the roller 10 can be synchronised with the unwinding speed of the foil 3.

In a preferred embodiment the roller 10 is provided with an anti-slip coating or cover or the roller 10 itself is made of anti-slip material.

This can, for example, be realised by manufacturing the roller 10 from rubber or by providing a rubber layer around the roller.

As shown on FIG. 1, the needle block 4 is located opposite the roller 10. However, this is not necessary for the invention.

In this case, the needle block 4 is only movable away from and toward the roller 10.

This means that the needles 6 can be moved down, toward the roller 10, to enable the printing of the colour on the object and that the needles 6 can be moved up, away from the roller 10, to position and remove an object 2.

A movement of the needle block 4 in a horizontal plane, i.e. over the object 2 to be printed, as is necessary with the traditional installations 1, is not possible in this embodiment.

In this case, but not necessary for the invention, the device 1 is provided with a collapsible or removable guide plate 11a, 11b that will guide an object 2 to be printed over the roller 10.

The guide plate 11a, 11b can be executed in different ways and as shown in the figures, may also consist of different parts 11a, 11b.

In this case there are two parts 11a, 11b, on either side of the roller 10.

Both parts 11a, 11b are removable in this case, but they could also be collapsible.

In this way the guide plate 11a, 11b can be removed when the device 1 is not in use, such that it becomes very compact and does not take up much room.

The operation of the installation 1 is very simple and as follows.

First, the guide plate 11a, 11b is mounted to the device 1, as shown in the FIGS. 1 and 2.

An object 2 to be printed, such as, for example, a cover, is put on the guide plate 11a, 11b, as shown in FIG. 2 and the needle block 4 is moved to the roller 10. This means the cover will make contact with the foil 3 inserted in the device 1.

The control unit 5 will then control the needle block 4.

The control unit 5 will heat the needles 6, based on the image or text to be printed, according to a certain pattern while at the same time the roller 10 will be powered, such that the cover moves under the needle block 4 as it were.

By heating certain needles 6, the hotmelt adhesive will melt locally on the foil 3.

Because the foil 3 makes contact with the cover, the melted hotmelt adhesive will stick to the surface of the cover. Together with the hotmelt adhesive, the coloured foil will also stick to the cover.

By powering the roller 10, the cover will move under the needles 6, while the control unit 4 will rotate the drums 8 at the same time such that the foil 3 will slide further under the needle block 4 and will heat certain other needles 6 according to said pattern.

Consequently, the next part of the image or text can be printed on the cover.

As the roller 10 is located opposite needle block 4, the needles 6 will be able to exert a certain pressure on the cover and on the foil 3. This ensures good contact between the needles 6, the foil 3 and the cover, such that a good adhesion of the hotmelt adhesive and the silver or gold foil on the cover can be ensured.

The printing is continued in this continual way until the desired image or text is printed on the cover.

Then the needle block 4 is moved up and the cover can be removed.

It is also possible of course that the needle block 4 is not moved up, but that the roller 10 continues to rotate until the cover has slid completely under the needle block 4 and ends up on the other part of the guide plate 11a, 11b where it can be removed.

Subsequently the next object 2 to be printed can be put on the guide plate 11a, 11b and the action can be repeated.

FIG. 3 illustrates that, for example, in the event the object 2 is a stiff folder to be printed with a spine 12 and two stiff end leaves 13, the guide plates 11a and 11b can possibly be left out.

In this case the folder 2 is positioned with one of its end leaves 13 above the roller as shown in FIG. 3, with the spine 12 next to the roller 10.

By moving the needles 6 down, the end leaf in question of the folder 2 will automatically level out and upon powering of the roller 10, will move laterally while the print is printed on the end leaf 13.

In an alternative embodiment, not shown in the figures, the device 1 is provided with two rollers 10 that are installed rotatably and next to each other, whereby the rollers 10 extend with their axes parallel to each other.

The advantage of such embodiment is that a level, rigid object 2, such as a cardboard cover or the like, can rest in a stable way on the two rollers 10 during the printing with foil 3 using the device 1 according to the invention.

Indeed, because the object 2 can rest on the two rollers 10 and thus has two points of support, it will be stable under the needle block 4.

Furthermore, two powered rollers 10 will also guide a heavier object well under the needle block 4, as two rollers 10 will drive the object forward.

An added advantage is that a round object 2, such as, for example, a pen, can be put between the two rollers 10. By powering the two rollers 10, the pen will rotate, such that it can be printed with the device 1.

Preferably, the distance between the two rollers 10 will be adjustable, such that round objects 2 with different diameters can be printed.

It is clear that it is not excluded that the device 1 is provided with more than two rollers 10, but this will be disadvantageous for the compactness of the device 1.

The present invention is by no means limited to the embodiments described as an example and shown in the figures, but a device for printing an object with a foil according to the invention can be realised in all kinds of forms and dimensions without departing from the scope of the invention.

1. Device for printing an object (2) with a foil (3), which device (1) comprises a needle block (4) with needles (6) that can be heated, a control unit (5) that can determine and set which needles (6) are heated at which moment, wherein the device (1) is also provided with a roller (10) that is positioned rotatably and which can guide the object (2), when placed on the roller (10), under the needle block (5).

2. Device according to claim 1, wherein the needle block (5) is located opposite the roller (10).

3. Device according to claim 1, wherein the needle block (4) is only movable away and toward the roller (10).

4. Device according to claim 1, wherein the roller (10) is powered.

5. Device according to claim 1, wherein the device (1) is provided with a collapsible or removable guide plate (11a, 11b) that will guide an object (2) to be printed over the roller (10).

6. Device according to claim 1, wherein the device (1) is provided with two drums (8) on either side of the needle block (4) on which foil (3) can be rolled and unrolled respectively, whereby this foil (3) passes along or over the needle block (4).

7. Device according to claim 1, wherein the roller (10) is provided with an anti-slip coating or cover or that the roller (10) itself is made of an anti-slip material.

8. Device according to claim 1, wherein the device (1) is provided with two rollers (10) that are positioned rotatably and next to each other, whereby the rollers (10) extend with their axes parallel to each other.

9. Device according to claim 2, wherein the needle block (4) is only movable away and toward the roller (10).

10. Device according to claim 2, wherein the roller (10) is powered.

11. Device according to claim 3, wherein the roller (10) is powered.

12. Device according to claim 2, wherein the device (1) is provided with a collapsible or removable guide plate (11a, 11b) that will guide an object (2) to be printed over the roller (10).

13. Device according to claim 3, wherein the device (1) is provided with a collapsible or removable guide plate (11a, 11b) that will guide an object (2) to be printed over the roller (10).

14. Device according to claim 4, wherein the device (1) is provided with a collapsible or removable guide plate (11a, 11b) that will guide an object (2) to be printed over the roller (10).

15. Device according to claim 2, wherein the device (1) is provided with two drums (8) on either side of the needle block (4) on which foil (3) can be rolled and unrolled respectively, whereby this foil (3) passes along or over the needle block (4).

16. Device according to claim 3, wherein the device (1) is provided with two drums (8) on either side of the needle block (4) on which foil (3) can be rolled and unrolled respectively, whereby this foil (3) passes along or over the needle block (4).

17. Device according to claim 4, wherein the device (1) is provided with two drums (8) on either side of the needle block (4) on which foil (3) can be rolled and unrolled respectively, whereby this foil (3) passes along or over the needle block (4).

18. Device according to claim 5, wherein the device (1) is provided with two drums (8) on either side of the needle block (4) on which foil (3) can be rolled and unrolled respectively, whereby this foil (3) passes along or over the needle block (4).

19. Device according to claim 2, wherein the roller (10) is provided with an anti-slip coating or cover or that the roller (10) itself is made of an anti-slip material.

20. Device according to claim 3, wherein the roller (10) is provided with an anti-slip coating or cover or that the roller (10) itself is made of an anti-slip material.
